(19) United States
(12) Patent Application Publication
(10) Pub. No.: US 2026/0300611 A1
(43) Pub. Date: Oct. 1, 2026

(54) WEBSITE LINK EXTRACTION METHOD AND APPARATUS, STORAGE MEDIUM, AND ELECTRONIC DEVICE

(71) Applicant: Beijing Youzhuju Network Technology Co., Ltd., Beijing (CN)

(72) Inventor: Wenjie YANG, Beijing (CN)

(21) Appl. No.: 18/880,498

(22) PCT Filed: Dec. 27, 2023
(86) PCT No.: PCT/CN2023/142240

§ 371 Date: Dec. 31, 2024

(30) Foreign Application Priority Data
Jan. 6, 2023 (CN) 202310021128.5

(51) Int. Cl. G06F 40/134; G06F 16/955

(52) U.S. Cl. CPC G06F 40/134; G06F 16/9558

(57) ABSTRACT

A website link extraction method and apparatus, a storage medium and an electronic device. The method includes determining a website extraction function according to an element class included in a source code of a page to be analyzed, and by means of the website extraction function, extracting from the element class a target website link included in said page.

### CROSS-REFERENCE TO RELATED APPLICATIONS

The present application is based on and claims priority to Chinese Application No. 202310021128.5, filed on Jan. 6, 2023, the disclosure of the Chinese Application is hereby incorporated by reference in its entirety.

### FIELD OF THE INVENTION

The present disclosure relates to the field of computer technology, and in particular to website link extraction method and apparatus, a storage medium, and an electronic device.

### BACKGROUND

In some landing pages for consultation, the landing pages may include some call to action (CTA) buttons, and the CTA buttons may be used for jumping to a consultation link.

### DISCLOSURE OF THE INVENTION

The DISCLOSURE OF THE INVENTION section is provided to introduce concepts in a brief form, which will be described in detail in the DETAILED DESCRIPTION OF PREFERRED EMBODIMENTS section later. The DISCLOSURE OF THE INVENTION section is not intended to identify key features or essential features of the claimed technical solutions, nor intended to limit the scope of the claimed technical solution.

In a first aspect, an embodiment of the present disclosure provides a method of extracting a website link, including:
acquiring source codes of a page to be analyzed;
determining an element class included in the source codes; and
based on a website extraction function matching the element class, extracting a target website link included in the page to be analyzed from the element class.

In a second aspect, an embodiment of the present disclosure provides an apparatus for extracting a website link, including:
an acquisition module configured to acquire source codes of a page to be analyzed;
a determination module configured to determine an element class included in the source code; and
an extraction module configured to, based on a website extraction function matching the element class, extract a target website link included in the page to be analyzed from the element class.

In a third aspect, an embodiment of the present disclosure provides a computer-readable storage medium having a computer program stored thereon, wherein the program, when executed by a processing device, implements the steps of the method according to the first aspect.

In a fourth aspect, an embodiment of the present disclosure provides an electronic device, including:
a storage device having a computer program stored thereon; and
a processing device configured to execute the computer program in the storage device, to implement the steps of the method according to the first aspect.

In a fifth aspect, an embodiment of the present disclosure provides a computer program product that includes a computer program and/or instructions, wherein the computer program and/or instructions, when running on a computer, cause the computer to implement the steps of the method according to the first aspect.

In a sixth aspect, an embodiment of the present disclosure provides a computer program that includes program codes, wherein the program codes, when executed by a processor, implement the steps of the method according to the first aspect.

Other features and advantages of the present disclosure will be described in detail in the following DETAILED DESCRIPTION OF PREFERRED EMBODIMENTS section.

### DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is a flowchart of a method of extracting a website link according to an exemplary embodiment.

FIG. 2 is a detailed flowchart of step 130 shown in FIG. 1.

FIG. 3 is a flowchart of a method of extracting a website link according to another exemplary embodiment.

FIG. 4 is a schematic diagram of module connections in an apparatus for extracting a website link according to an exemplary embodiment.

FIG. 5 is a schematic structural diagram of an electronic device according to an exemplary embodiment.

### DETAILED DESCRIPTION OF PREFERRED EMBODIMENTS

Embodiments of the present disclosure will be described in more detail below with reference to the accompanying drawings. Although some embodiments of the present disclosure are shown in the drawings, it should be understood that the present disclosure can be embodied in various forms and should not be construed as being limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”; the term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a” and “a plurality” mentioned in the present disclosure are schematic rather than limiting, and those skilled in the art should understand that unless the context clearly indicates otherwise, they should be understood as “one or more”.

Names of messages or information exchanged among multiple devices in the embodiments of the present disclosure are only used for illustrative purposes, and are not used to limit the scope of these messages or information.

It may be understood that before using the technical solutions disclosed in the embodiments of the present disclosure, a user should be informed of the type, range of usage, usage scenario, etc. of personal information involved in the present disclosure in an appropriate manner in accordance with relevant laws and regulations, and the authorization of the user should be obtained.

For example, in response to receiving an active request from a user, prompt information is sent to the user to clearly inform the user that the operation requested to be performed will require access to and usage of the user's personal information. In this way, the user may independently choose whether to provide the personal information to software or hardware such as an electronic device, an application, a server, or a storage medium that performs the operation of the technical solution of the present disclosure according to the prompt information.

As an optional but non-limiting implementation, in response to receiving an active request from the user, the prompt information may be sent to the user in the form of a pop-up window, for example, and the prompt information may be presented in text in the pop-up window. In addition, the pop-up window may further include a selection control for the user to choose whether to “agree” or “disagree” to provide the personal information to the electronic device.

It may be understood that the above process of notifying and acquiring the authorization from the user is merely illustrative and is not intended to limit the implementations of the present disclosure. Other manners that satisfy the requirements of relevant laws and regulations may also be applied to the implementations of the present disclosure.

In addition, it may be understood that the data involved in the technical solution (including but not limited to the data itself, the acquisition of the data, or the usage of the data) should comply with the requirements of corresponding laws, regulations, and related provisions.

Current landing pages for consultation generally have only a jump function, but lack other functions such as data detection and analysis, or the like. Therefore, there is a need to convert the landing page for consultation into a landing page with more functions, and therefore there is a need to extract a website included in the landing page for consultation. However, due to the variety of page jump manners used in the landing page for consultation, the extraction of a consultation link is extremely complicated, therefore, there is an urgent need for a website extraction method.

In view of this, embodiments of the present disclosure provide improved website link extraction method and apparatus, storage medium, and electronic device.

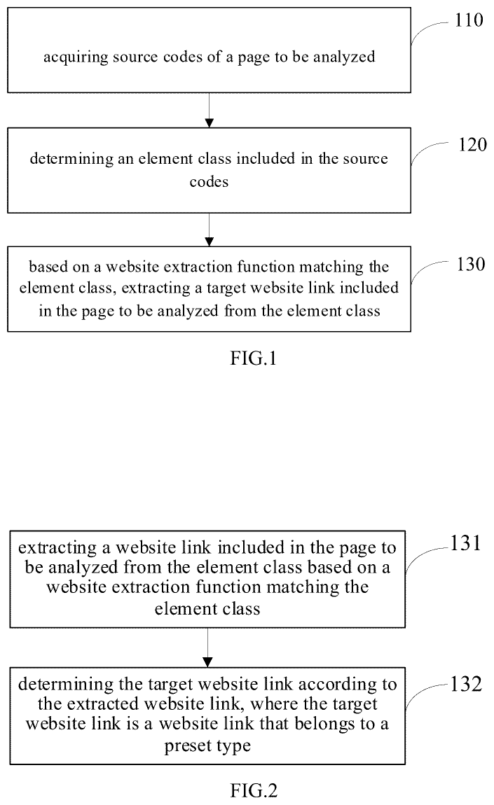

FIG. 1 is a flowchart of a method of extracting a website link according to an exemplary embodiment. As shown in FIG. 1, an embodiment of the present disclosure provides a method of extracting a website link. The method may be performed by an electronic device, and may specifically be performed by an apparatus for extracting a website link, the apparatus may be implemented by software and/or hardware, and is configured in the electronic device. As shown in FIG. 1, the method may include the following steps.

In step 110, source codes of a page to be analyzed are acquired.

Here, the page to be analyzed refers to a landing page for consultation, and the landing page includes some call to action (CTA) buttons, the CTA button is used for jumping to a certain consultation link. The consultation link may refer to a website link provided by an advertiser and pointing to a certain social software or a certain website.

It should be noted that the page to be analyzed may be a page in an application or a web page.

It should be understood that the technique for extracting source codes of a page to be analyzed is mature in the prior art, and will not be described in detail in the embodiments of the present disclosure. For example, the source codes of a page to be analyzed that is of a web page type may be obtained by using the manner of “viewing source codes of the web page”.

In step 120, an element class included in the source code is determined.

Here, the source codes of the page to be analyzed is generally written in hypertext markup language (HTML), each HTML in the source codes consists of character strings, and the character strings are reflected as element classes (HTML element classes) in a browser environment. The element class may be an HTML DivElement or an HTML SpanElement.

Exemplarily, the element class included in the source codes may be determined through the character strings of the source codes.

In step 130, a target website link included in the page to be analyzed is extracted from the element class based on a website extraction function matching the element class.

Here, different types of element classes may correspond to different website extraction functions. The type of an element class is used for characterizing a manner in which the element class implements a website link jump. Element classes that implement website link jumps in different manners belong to different types. For example, in a HTML page, an element class that uses an anchor tag (anchor) and performs a page jump by filling in a website link in a hypertext reference (href) of the anchor is a type of element class. Alternatively, in an HTML page, an element class that uses an anchor tag (anchor) and performs a page jump by filling in a website jump function in a hypertext reference (href) of the anchor tag is another type of element class. Alternatively, an element class that performs a page jump by using a window. open( ) function is another type of element class. Alternatively, an element class that performs a page jump by using a location. href function is another type of element class.

For different types of element classes, it is possible to extract the website link included in the page to be analyzed from the element classes by using different website extraction functions, and then determine a target website link from the extracted website links. The website extraction function may extract all website links included in the page to be analyzed from the page to be analyzed, and the target website link may be one or more website links that are determined from all the website links extracted from the page to be analyzed and that are required.

It should be noted that different website extraction functions may perform different functions. For example, a website extraction function may be used for proxying and executing an element class, to obtain a website link to which the element class finally points. For another example, a website extraction function may be used for directly extracting from an element class a website link to which the element class points. For another example, a website extraction function may be used for performing an abstract syntax tree analysis on an element class, so as to obtain a website link to which the element class finally points. Therefore, different website extraction functions may be used for different types of element classes.

It should be understood that the extracted target website link may be used for generating a target page. The target page may be a page in a target application. In some application scenarios, the page to be analyzed may be a third-party page, and the third-party page generally has only a simple page jump function. Therefore, the third-party page may be converted into a first-party page with more functions. For example, the page to be analyzed may be a web page of a browser, and a page of an application can be generated by extracting a target website link in the web page and loading the extracted target website link into the page of the application. Certainly, the extracted target website link may also be used in other application scenarios.

In this way, by determining a website extraction function according to an element class included in source codes of a page to be analyzed, and extracting a target website link included in the page to be analyzed from the element class by using the website extraction function, a website link included in a page to be analyzed that uses different technologies to perform page jumps can be accurately extracted from the page to be analyzed.

In some embodiments of the present disclosure, after step 120, the element class may be encapsulated to obtain an encapsulated element class.

Here, a HTML element class is an API (Application Programming Interface) of a document (which is a computer term, every HTML document loaded into a browser will become a document object). In the process of extracting a website link from the element class based on the website extraction function, the same attribute may be acquired multiple times, which will cause the same function to be called multiple times. By encapsulating the element class, the encapsulated element class may store values after calling in advance, for example, getComputedStyle( ) and getAttribute( ), etc.

In addition, since the element class has a tree structure, and the tree structure is very inconvenient when website link extraction is performed on each element class, this problem may be solved by encapsulating the element class.

It should be noted that after the element class is encapsulated to obtain the encapsulated element class, the subsequent steps are performed on the encapsulated element class. For example, in the above step 130, the target website link included in the page to be analyzed is extracted from the encapsulated element class based on the website extraction function matching the element class.

In some embodiments of the present disclosure, in step 130, a website extraction function may be determined according to a character string included in the element class, and the target website link may be extracted from the element class by using the website extraction function, where the character string is used for characterizing the manner in which the element class implements the website link jump.

Here, an element class consists of character strings, when the element class uses different manners of implementing the website link jump, the character strings included in the element class are also different. For example, if the element class uses an anchor tag and performs a page jump by filling in a website link in a hypertext reference of the anchor tag, the element class may include a character string of “<a href=”. If the element class performs a page jump by using a window.open( ) function, the element class may include a character string of “window.open”.

The character string included in the element class actually reflects the manner in which the element class implements a website link jump, the manner in which the element class implements a website link jump may be accurately determined through the character string included in the element class, so that the website extraction functions corresponding to the different types of element classes may be determined more accurately.

By determining the website extraction function according to the character string included in the element class, for element classes that use different manners of website link jumps, a target website link may be extracted from an element class by using the website extraction function matching the manner of the website link jump.

In this way, the manner of the website link jump used by the element class may be accurately determined through the character string included in the element class, so that the corresponding website link extraction function may be accurately determined, and the target website link may be accurately extracted from the page to be analyzed.

In some embodiments of the present disclosure, when a character string of the element class includes an anchor tag and the hypertext reference of the anchor tag includes a first target character string used for characterizing a target script language, by proxying and executing a website jump function to which the hypertext reference points by using a first website extraction function, a website link to which the website jump function points can be obtained; and the target website link can be determined according to the website link to which the website jump function points.

Here, the anchor tag may be “<a”, in an HTML document, every time “<a” appears, an Anchor object can be created, and the anchor may be used for creating a connection pointing to another document through a href (Hypertext Reference) attribute. The target script language is javascript, and a first target character string used for characterizing the target script language may be “javascript:”.

It should be understood that if the character string of the element class includes an anchor tag and the hypertext reference of the anchor tag includes the first target character string, which represents that the element class implements a website link jump by executing a function written in the target script language, by proxying and executing the website jump function to which the hypertext reference points by using the first website extraction function, the website link to which the website jump function points can be obtained.

For example, the element class may include a character string of “<a href=“javascript:{toConsultingLink( )}””, the element class includes the anchor tag “<a” and the second target character string of “javascript:”, by proxying and executing the website jump function “javascript:{toConsultingLink( )}” executed by “href” by using the first website extraction function, the website link to which the website jump function points can be obtained.

It should be noted that the first website extraction function may be getHrefByClick( ), and the first website extraction function can be used for proxying a website jump function in the element class that may trigger a page jump and executing the website jump function. When the first website extraction function executes the website jump function, it does not mean that a switch will actually be made from the page to be analyzed to a page corresponding to the website jump function, the first website extraction function may obtain the website link to which the website jump function points, while preventing the page jump behavior of the website jump function.

After the website link to which the website jump function points has been obtained, the target website link can be determined according to the website link to which the website jump function points. The website link to which the website jump function points is not necessarily a required consultation link, therefore, a target website link may be determined according to the obtained website link to which the website jump function points, where the target website link is a website link that belongs to a preset type.

For example, the obtained website link to which the website jump function points may be matched with a pre-configured website link of a preset type, and the website link to which the website jump function points that is successfully matched is determined as the target website link.

In this way, when the character string of the element class includes the anchor tag and the hypertext reference of the anchor tag includes a first target character string used for characterizing a target script language, by proxying and executing the website jump function to which the hypertext reference points by using the first website extraction function, the website link can be accurately and quickly extracted from the element class, thereby determining the target website link.

In some embodiments of the present disclosure, when the character string of the element class includes the anchor tag and the hypertext reference of the anchor tag does not include a first target character string used for characterizing a target script language, by extracting a website link to which the hypertext reference points by using a second website extraction function, the target website link can be determined according to the extracted website link.

Here, the relevant descriptions of the anchor tag and the first target character string have been described in detail in the above embodiments, and will not be repeated here. It should be noted that, the hypertext reference of the anchor tag does not include the first target character string used for characterizing the target script language may also mean that the hypertext reference of the anchor tag points to the website link.

For example, if the element class may include a character string of “<a href=https://wa.me”, the element class includes the anchor tag “<a”, and the hypertext reference “href” of the anchor tag does not point to the first target character string but points to the website link, the website link to which the hypertext reference “href” points may be directly extracted by using the second website extraction function, so as to obtain the website link included in the page to be analyzed.

It should be noted that the second website extraction function may be different from the first website extraction function, the first website extraction function is used for proxying and executing the website jump function, and the second website extraction function is used for directly extracting the website link from the element class.

After the website link is extracted, the target website link may be determined according to the extracted website link. The extracted website link is not necessarily the required consultation link, and the target website link may be determined according to the obtained extracted website link, where the target website link is a website link that belongs to a preset type.

For example, the extracted website link may be matched with a pre-configured website link of a preset type, and the extracted website link that is successfully matched can be determined as the target website link.

In this way, when the character string of the element class includes the anchor tag and the hypertext reference of the anchor tag does not include the first target character string used for characterizing the target script language, by extracting the website link to which the hypertext reference points by using the second website extraction function, the website link can be accurately and quickly extracted from the element class, thereby determining the target website link.

In some embodiments of the present disclosure, when the character string of the element class includes a second target character string used for characterizing a mouse click event and a third target character string used for characterizing that the mouse click event is implemented by calling a method of opening a new window, by extracting a target parameter in the method of opening the new window by using a third website extraction function to obtain a website link included in the element class, the target website link can be determined according to the website link included in the element class.

Here, the second target character string is used for characterizing a mouse click event (onclick), and the mouse click event refers to when a mouse is clicked on a web page, a program block associated with the mouse click event is executed. For example, the second target character string may be “button”. That the character string of the element class includes the second target character string used for characterizing the mouse click event actually represents that the element class implements a page jump by clicking the button.

The third target character string is used for characterizing that the mouse click event is implemented by calling the method of opening the new window. That the mouse click event is implemented by calling the method of opening the new window refers to that the page jump is implemented by calling a “window.open( )” function, window.open( ) is the method that is called for opening the new window, and the second target character string may refer to “window.open( )”.

When the character string of the element class includes the second target character string and the third target character string, it means that the element class implements the page jump by triggering calling of window.open( ) through clicking the button, therefore a target parameter in window.open( ) may be extracted by using the third website extraction function, where the target parameter is a parameter that characterizes the website link. It should be noted that the target parameter may be the 0th actual parameter in window.open( ), and the 0th actual parameter is generally a website link. The website link included in the element class may be obtained by extracting the target parameter in the method of opening the new window.

It should be understood that the third website extraction function is different from the first website extraction function, the first website extraction function is used for proxying and executing the website jump function, and the third website extraction function is used for directly extracting the website link from window.open( ).

After the website link included in the element class is obtained, the target website link may be determined according to the website link included in the element class. The website link included in the element class is not necessarily the required consultation link, and the target website link may be determined according to the obtained website link included in the element class, where the target website link is a website link that belongs to a preset type.

For example, the website link included in the element class may be matched with a pre-configured website link of a preset type, and the website link that is successfully matched may be determined as the target website link.

In this way, when the character string of the element class includes the second target character string and the third target character string, by extracting the target parameter in the method of opening the new window by using the third website extraction function, the website link can be accurately and quickly extracted from the element class, thereby determining the target website link.

In some embodiments of the present disclosure, when the character string of the element class includes the second target character string used for characterizing the mouse click event and does not include the third target character string used for characterizing that the mouse click event is implemented by calling the method of opening the new window, by proxying and executing the mouse click event by using a fourth website extraction function, a website link to which the mouse click event points can be obtained; and the target website link can be determined according to the website link to which the mouse click event points.

Here, the second target character string and the third target character string have been described in detail in the above embodiments, and will not be repeated here. That the character string of the element class does not include the third target character string used for characterizing that the mouse click event is implemented by calling the method of opening the new window means that the mouse click event of the element class is not implemented by calling window.open( ), but the page jump is implemented by executing a program block associated with the mouse click event.

When the character string of the element class includes the second target character string and does not include the third target character string, by proxying and executing the mouse click event by using the fourth website extraction function, the website link to which the mouse click event points can be obtained. The fourth website extraction function proxies and executes the mouse click event means that the fourth website extraction function clicks the element class to cause the element class to trigger the mouse click event, so as to execute a program block associated with the mouse click event and obtain the website link to which the mouse clicks event points. It should be noted that when the fourth website extraction function executes the mouse click event, it does not mean that a switch will actually be made from the page to be analyzed to a page corresponding to the mouse click event, the fourth website extraction function may obtain the website link which the mouse click event points, while preventing the switch to the page of the mouse click event.

It should be understood that the fourth website extraction function may perform the same function as the first website extraction function, that is, the fourth website extraction function is used for proxying and executing a function included in the element class that may trigger a page jump. The fourth website extraction function may be getHrefByClick( ).

After the website link to which the mouse click event points is obtained, the target website link may be determined according to the website link to which the mouse click event points. The website link to which the mouse click event points is not necessarily the required consultation link, and the target website link may be determined according to the website link to which the mouse click event points, where the target website link is a website link that belongs to a preset type.

For example, the website link to which the mouse click event points may be matched with a pre-configured website link of a preset type, and the website link that is successfully matched can be determined as the target website link.

In this way, when the character string of the element class includes the second target character string used for characterizing the mouse click event and does not include the third target character string used for characterizing that the mouse click event is implemented by calling the method of opening the new window, by proxying and executing the mouse click event by using a fourth website extraction function, the website link can be accurately and quickly extracted from the element class, thereby determining the target website link.

In some embodiments of the present disclosure, when the character string of the element class does not include an anchor tag and does not include the second target character string used for characterizing the mouse click event, if the height of the element class is less than a preset pixel value, by proxying and executing the element class by using a fifth website extraction function, a website link to which the element class points can be obtained; and the target website link is determined according to the website link to which the element class points.

Here, the anchor tag and the second target character string have been described in detail in the above embodiments, and will not be repeated here. That the character string of the element class does not include an anchor tag and does not include the second target character string used for characterizing the mouse click event means that the element class does not trigger a page jump by an anchor nor trigger a page jump by a mouse click event.

When the character string of the element class does not include an anchor tag and does not include the second target character string used for characterizing the mouse click event, if the height of the element class is less than a preset pixel value, it means that the element class is a virtual button, and the element class may be proxied and executed by using a fifth website extraction function, so as to obtain a website link to which the element class points. In HTML, not all virtual buttons may use “<button>” and “input”, and “<div>” may be used to modify CSS to make the element class look like a virtual button in appearance. When the character string of the element class does not include an anchor tag and does not include the second target character string used for characterizing the mouse click event, if the height of the element class is less than a preset pixel value, it means that the element class is caused to look like a virtual button by means of the manner of using “<div>” to modify CSS.

It should be noted that that the fifth website extraction function proxies and executes the element class means that the fifth website extraction function clicks the element class to jump to the website link that is pointed to, so as to obtain the website link to which the element class points. The fifth website extraction function may be getHrefByClick( ). The fifth website extraction function may perform the same function as the first website extraction function, that is, the fifth website extraction function is used for proxying and executing a function included in the element class that may trigger a page jump.

After the website link to which the element class points is obtained, the target website link is determined according to the website link to which the element class points. The website link to which the element class points is not necessarily the required consultation link, and the target website link may be determined according to the website link to which the element class points, where the target website link is a website link that belongs to a preset type.

For example, the website link to which the element class points may be matched with a pre-configured website link of a preset type, and the website link that is successfully matched is determined as the target website link.

In this way, when the character string of the element class does not include an anchor tag and does not include the second target character string used for characterizing the mouse click event, if the height of the element class is less than a preset pixel value, by proxying and executing the element class by using a fifth website extraction function, the website link can be accurately and quickly extracted from the element class, thereby determining the target website link.

In some embodiments of the present disclosure, when the character string of the element class includes a fourth target character string used for characterizing that a page jump is performed by a function for jumping from a current page, if the function for jumping from the current page points to a website link, by using a sixth website extraction function, the website link to which the function for jumping from the current page points can be extracted; and the target website link can be determined according to the extracted website link.

Here, the function for jumping from the current page refers to location.href, and the fourth target character string may refer to location.href. Since location.href cannot be proxied and blocked, a script of location.href may be analyzed. If the function for jumping from the current page points to the website link, the website link to which the function for jumping from the current page points may be directly extracted by using the sixth website extraction function.

For example, if location.href=‘xxx.url’, xxx.url can be directly extracted by using the sixth website extraction function, so as to obtain the website link to which the function for jumping from the current page points.

It should be noted that the sixth website extraction function is used for directly extracting the website link pointed to by the function for jumping from the current page from the function for jumping from the current page.

After the website link is extracted, the target website link may be determined according to the extracted website link. The extracted website link is not necessarily the required consultation link, and the target website link may be determined according to the obtained extracted website link, where the target website link is a website link that belongs to a preset type.

For example, the extracted website link may be matched with a pre-configured website link of a preset type, and the extracted website link that is successfully matched may be determined as the target website link.

In this way, when the character string of the element class includes a fourth target character string used for characterizing that a page jump is performed by a function for jumping from a current page, if the function for jumping from the current page points to a website link, by extracting the website link to which the function for jumping from the current page points by using a sixth website extraction function, the website link can be accurately and quickly extracted from the element class, thereby determining the target website link.

In some embodiments of the present disclosure, when the character string of the element class includes a fourth target character string used for characterizing that a page jump is performed by a function for jumping from a current page, if the function for jumping from the current page points to a variable, by performing an abstract syntax tree analysis on the function for jumping from the current page by using a seventh website extraction function, a website link to which the function for jumping from the current page finally points can be obtained; and the target website link can be determined according to the obtained website link.

Here, the fourth target character string has been described in detail in the above embodiments, and will not be repeated here. Since location.href cannot be proxied and blocked, a script of location.href may be analyzed. If location.href points to a variable, the abstract syntax tree analysis may be performed on the function for jumping from the current page by using the seventh website extraction function, so as to obtain the website link to which the function for jumping from the current page finally points.

For example, if location.href=‘a’, where a is a variable, an abstract syntax tree (AST) analysis may be performed on location.href=‘a’ by using the seventh website extraction function, so as to obtain a syntax tree structure thereof, thereby obtaining the website link to which the function for jumping from the current page finally points. For example, the syntax tree structure of location.href=‘a’ is: a-b-c-d-e-url, and url is the website link to which the function for jumping from the current page finally points.

It should be noted that the seventh website extraction function performs different functions from the first website extraction function and the second website extraction function, the seventh website extraction function is used for performing the abstract syntax tree analysis on the function for jumping from the current page, so as to obtain the website link to which the function for jumping from the current page finally points.

After the website link is obtained, the target website link can be determined according to the obtained website link. The obtained website link is not necessarily the required consultation link, and the target website link may be determined according to the obtained website link, where the target website link is a website link that belongs to a preset type.

For example, the obtained website link may be matched with a pre-configured website link of the preset type, and the extracted website link that is successfully matched may be determined as the target website link.

In this way, when the character string of the element class includes a fourth target character string used for characterizing that a page jump is performed by a function for jumping from a current page, if the function for jumping from the current page points to a variable, by performing an abstract syntax tree analysis on the function for jumping from the current page by using a seventh website extraction function, the website link can be accurately and quickly extracted from the element class, thereby determining the target website link.

FIG. 2 is a detailed flowchart of step 130 shown in FIG. 1. As shown in FIG. 2, step 130 may include the following steps.

In step 131, a website link included in the page to be analyzed is extracted from the element class based on a website extraction function matching the element class.

Here, reference may be made to the related descriptions in the above embodiments for the determination of the website extraction function, which will not be repeated here.

In step 132, the target website link is determined according to the extracted website link, where the target website link is a website link that belongs to a preset type.

Here, after the website link is extracted, a regular matching may be performed between the extracted website link and the pre-configured website link of the preset type through, and the website link that is successfully matched is the target website link. For example, the website link of the preset type may be a website configured by the user.

In this way, by selecting the website link that belongs to the preset type from the extracted website links as the target website link, a consultation link required by the user may be accurately extracted from the page to be analyzed.

In some embodiments of the present disclosure, a website type to which the target website link belongs may also be marked, so that when a target page is generated, a color matching the website type may be filled in a target position in the target page according to the website type. For example, if the target website link is a website link of an application A, the website type may be marked as A, and the color matching the website type A may be the icon color of the application A.

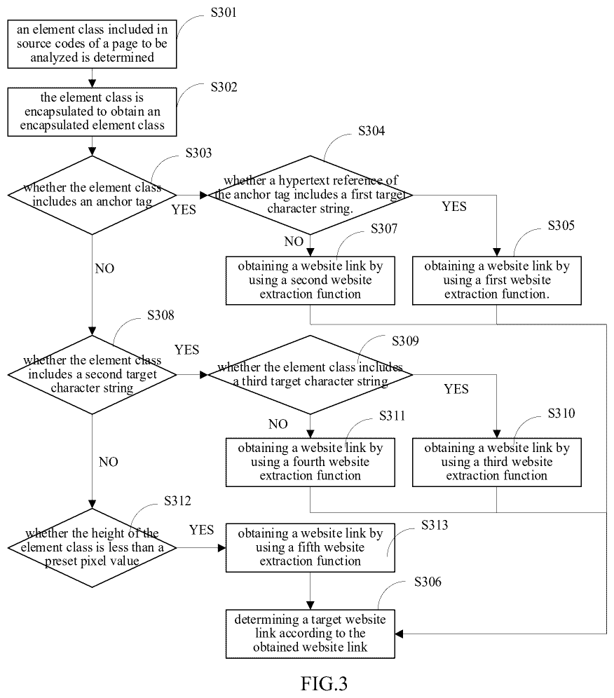

The above embodiments will be described in detail below with reference to FIG. 3.

FIG. 3 is a flowchart of a method of extracting a website link according to another exemplary embodiment. As shown in FIG. 3, the method may include the following steps.
In S301, an element class included in source codes of a page to be analyzed is determined.
In S302, the element class is encapsulated to obtain an encapsulated element class.
In S303, it is determined whether the element class includes an anchor tag.
In S304, when the element class includes the anchor tag, it is further determined whether a hypertext reference of the anchor tag includes a first target character string.
In S305, when the hypertext reference of the anchor tag includes the first target character string, a website link is obtained by using a first website extraction function.
In S306, a target website link is determined according to the obtained website link.
In S307, when the hypertext reference of the anchor tag does not include the first target character string, a website link is obtained by using a second website extraction function.
In S308, when the element class does not include the anchor tag, it is further determined whether the element class includes a second target character string.
In S309, when the element class includes the second target character string, it is further determined whether the element class includes a third target character string.
In S310, when the element class includes the third target character string, a website link is obtained by using a third website extraction function.
In S311, when the element class does not include the third target character string, a website link is obtained by using a fourth website extraction function.
In S312, when the element class does not include the second target character string, it is further determined whether the height of the element class is less than a preset pixel value.
In S313, when the height of the element class is less than the preset pixel value, a website link is obtained by using a fifth website extraction function.

It should be noted that reference may be made to the related descriptions of the above embodiments for the detailed descriptions of S301 to S313 in the above embodiments, which will not be repeated here.

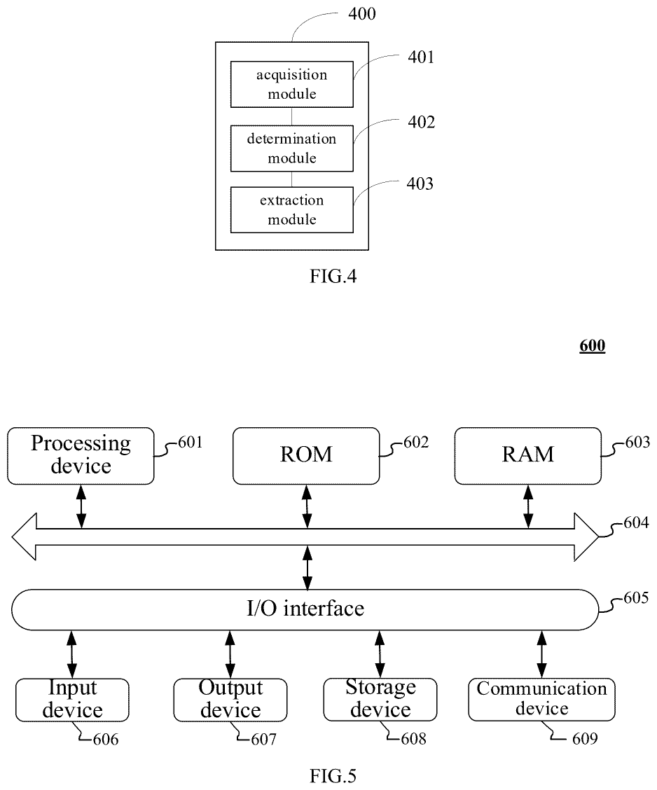

FIG. 4 is a schematic diagram of module connections in an apparatus for extracting a website link according to an exemplary embodiment. As shown in FIG. 4, the present disclosure provides an apparatus for extracting a website link. The apparatus 400 includes:
an acquisition module 401 configured to acquire source codes of a page to be analyzed;
a determination module 402 configured to determine an element class included in the source codes; and
an extraction module 403 configured to extract, based on a website extraction function matching the element class, a target website link included in the page to be analyzed from the element class.

Optionally, the extraction module 403 includes:
a first extraction unit configured to determine a website extraction function according to a character string included in the element class, and extract the target website link from the element class through the website extraction function, where the character string is used for characterizing a manner in which the element class implements a website link jump.

Optionally, the first extraction unit is specifically configured to:
when a character string of the element class includes an anchor tag and the hypertext reference of the anchor tag includes a first target character string used for characterizing a target script language, proxy and execute a website jump function to which the hypertext reference points through a first website extraction function, to obtain a website link to which the website jump function points;
determine the target website link according to the website link to which the website jump function points.

Optionally, the first extraction unit is specifically configured to:
when the character string of the element class includes the anchor tag and the hypertext reference of the anchor tag does not include a first target character string used for characterizing a target script language, extract a website link to which the hypertext reference points by using a second website extraction function,
determine the target website link according to the extracted website link.

Optionally, the first extraction unit is specifically configured to:
when the character string of the element class includes a second target character string used for characterizing a mouse click event and a third target character string used for characterizing that the mouse click event is implemented by calling a method of opening a new window, extract a target parameter in the method of opening the new window by using a third website extraction function to obtain a website link included in the element class, wherein the target parameter is a parameter characterizing the website link;
determine the target website link according to the website link included in the element class.

Optionally, the first extraction unit is specifically configured to:
when the character string of the element class includes a second target character string used for characterizing a mouse click event and does not include a third target character string used for characterizing that the mouse click event is implemented by calling a method of opening a new window, proxy and execute, by using a fourth website extraction function, the mouse click event to obtain the website link to which the mouse click event points; and
determine the target website link according to the website link to which the mouse click event points.

Optionally, the first extraction unit is specifically configured to:
when the character string of the element class does not include the anchor tag and does not include the second target character string used for characterizing the mouse click event, if the height of the element class is less than a preset pixel value, proxy and execute the element class by using a fifth website extraction function to obtain the website link to which the element class points; and
determine the target website link according to the website link to which the element class points.

Optionally, the first extraction unit is specifically configured to:
when the character string of the element class includes a fourth target character string used for characterizing that a page jump is performed by a function for jumping from a current page, if the function for jumping from the current page points to a website link, extract the website link to which the function for jumping from the current page points by using a sixth website extraction function; and
determine the target website link according to the extracted website link.

Optionally, the first extraction unit is specifically configured to:
when the character string of the element class includes a fourth target character string used for characterizing that a page jump is performed by a function for jumping from a current page, if the function for jumping from the current page points to the variable, perform an abstract syntax tree analysis on the function for jumping from the current page by using a seventh website extraction function, so as to obtain a website link to which the function for jumping from the current page finally points; and
determine the target website link according to the obtained website link.

Optionally, the apparatus 400 further includes:
an encapsulation module configured to encapsulate the element class to obtain an encapsulated element class.

Optionally, the extraction module 403 includes:
a second extraction unit configured to extract, based on the website extraction function matching the element class, the website link included in the page to be analyzed from the element class; and
a determination unit configured to determine the target website link according to the extracted website link, where the target website link is a website link that belongs to a preset type.

Regarding the apparatus 400 in the above embodiments, the method logic performed by each functional module has been described in detail in the section related to the method, and will not be repeated here.

Reference is made to FIG. 5 below, which shows a structural schematic diagram of an electronic device (such as a terminal device or a server) 600 suitable for implementing the embodiments of the present disclosure. The electronic devices in the embodiments of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV and desktop computers. The electronic device shown in FIG. 5 is only an example, and should not bring any limitation to the functions and application scopes of the embodiments of the present disclosure.

As shown in FIG. 5, an electronic device 600 may include a processing device (such as a central processing unit, a graphics processor, etc.) 601, which may perform various appropriate actions and processes according to a program stored in a read-only memory (ROM) 602 or a program loaded from a storage device 608 into a random-access memory (RAM) 603. In the RAM 603, various programs and data required for the operation of electronic device 600 are also stored. A processing device 601, a ROM 602 and a RAM 603 are connected to each other through a bus 604. An input/output (I/O) interface 605 is also connected to the bus 604.

Generally, the following devices can be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to communicate wirelessly or wired with other devices to exchange data. Although FIG. 5 shows an electronic device 600 with various equipment, it should be understood that it is not required to implement or have all the devices as shown. More or fewer devices may alternatively be implemented or provided.

In particular, according to embodiments of the present disclosure, the processes described above with reference to the flowcharts can be implemented as a computer software program. For example, an embodiment of the present disclosure includes a computer program product including a computer program carried on a non-transitory computer-readable medium, which contains program codes for executing the methods shown in the flowcharts. In such an embodiment, the computer program can be downloaded and installed from the network through the communication device 609, or installed from the storage device 608, or installed from the ROM 602. When the computer program is executed by the processing device 601, the above functions defined in the methods of the embodiments of the present disclosure can be implemented.

It should be noted that the computer-readable medium mentioned above in the present disclosure can be a computer-readable signal medium or a computer-readable storage medium or any combination of such two. The computer-readable storage medium can be, for example, but not limited to, an electrical, magnetic, optical, electromagnetic, infrared, or semiconductor system, apparatus or device, or a combination of the above. More specific examples of computer-readable storage media may include, but not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, and can send, propagate or transmit a program for use by or in connection with an instruction execution system, apparatus or device. The program codes contained in the computer-readable medium can be transmitted by any suitable medium, including but not limited to wires, optical cables, RF (radio frequency) and the like, or any suitable combination of the above.

In some embodiments, the electronic devices can communicate with each other by using any currently known or future to-be-developed network protocol such as HTTP (HyperText Transfer Protocol), and can be interconnected with digital data communication in any form or medium (for example, communication network). Examples of communication networks include a local area network (“LAN”), a wide area network (“WAN”), an internet network (for example, Internet) and end-to-end networks (for example, ad hoc end-to-end networks), as well as any currently known or future to-be-developed networks.

The computer-readable medium may be included in the above electronic device; or it can exist alone without being assembled into the electronic device.

The computer-readable medium carries one or more programs, and when the one or more programs are executed by the electronic device, the electronic device is caused to: acquire source codes of a page to be analyzed; determine an element class included in the source codes; and based on a website extraction function matching the element class, extract a target website link included in the page to be analyzed from the element class.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program codes can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architectures, functions and operations of possible implementations of systems, methods and computer program products according to various embodiments of the present disclosure. In this regard, each block in the flowchart or block diagram may represent a module, a program clip, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The modules involved in the embodiments described in the present disclosure can be realized by software or hardware. Among them, the name of the module does not constitute the limitation of the module itself in some cases.

The functions described above herein may be at least partially performed by one or more hardware logic components. For example, without limitation, exemplary types of hardware logic components that can be used may include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The above description is only the preferred embodiment of the present disclosure and the explanation of the applied technical principles. It should be understood by those skilled in the art that the disclosure scope involved in the present disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in the present disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A method of extracting a website link, comprising:
acquiring source codes of a page to be analyzed;
determining an element class comprised in the source codes; and
extracting, based on a website extraction function matching the element class, a target website link comprised in the page to be analyzed from the element class.

2. The method according to claim 1, wherein the extracting, based on the website extraction function matching the element class, the target website link comprised in the page to be analyzed from the element class, comprises:
determining a website extraction function according to a character string comprised in the element class, and extracting the target website link from the element class by using the website extraction function, wherein the character string is used for characterizing a manner in which the element class implements a website link jump.

3. The method according to claim 2, wherein the determining the website extraction function according to the character string comprised in the element class, and extracting the target website link from the element class by using the website extraction function, comprises:
in a case that the character string of the element class comprises an anchor tag and a hypertext reference of the anchor tag comprises a first target character string used for characterizing a target script language, proxying and executing, by using a first website extraction function, a website jump function to which the hypertext reference points, to obtain a website link to which the website jump function points; and
determining the target website link according to the website link to which the website jump function points.

4. The method according to claim 2, wherein the determining the website extraction function according to the character string comprised in the element class, and extracting the target website link from the element class by using the website extraction function, comprises:
in a case that the character string of the element class comprises an anchor tag and a hypertext reference of the anchor tag does not comprise a first target character string used for characterizing a target script language, extracting, by using a second website extraction function, a website link to which the hypertext reference points; and
determining the target website link according to the extracted website link.

5. The method according to claim 2, wherein the determining the website extraction function according to the character string comprised in the element class, and extracting the target website link from the element class by using the website extraction function, comprises:
in a case that the character string of the element class comprises a second target character string used for characterizing a mouse click event and a third target character string used for characterizing that the mouse click event is implemented by calling a method for opening a new window, extracting, by using a third website extraction function, a target parameter in the method for opening the new window to obtain a website link comprised in the element class, wherein the target parameter is a parameter that characterizes a website link; and
determining the target website link according to the website link comprised in the element class.

6. The method according to claim 2, wherein the determining the website extraction function according to the character string comprised in the element class, and extracting the target website link from the element class by using the website extraction function, comprises:
in a case that the character string of the element class comprises a second target character string used for characterizing a mouse click event and does not comprise a third target character string used for characterizing that the mouse click event is implemented by calling a method for opening a new window, proxying and executing, by using a fourth website extraction function, the mouse click event to obtain a website link to which the mouse click event points; and
determining the target website link according to the website link to which the mouse click event points.

7. The method according to claim 2, wherein the determining the website extraction function according to the character string comprised in the element class, and extracting the target website link from the element class by using the website extraction function, comprises:
in a case that the character string of the element class does not comprise an anchor tag and does not comprise a second target character string used for characterizing a mouse click event, if a height of the element class is less than a preset pixel value, proxying and executing the element class by using a fifth website extraction function to obtain a website link to which the element class points; and
determining the target website link according to the website link to which the element class points.

8. The method according to claim 2, wherein the determining the website extraction function according to the character string comprised in the element class, and extracting the target website link from the element class by using the website extraction function, comprises:
in a case that the character string of the element class comprises a fourth target character string used for characterizing that a page jump is performed by a function for jumping from a current page, if the function for jumping from the current page points to a website link, extracting, by using a sixth website extraction function, the website link to which the function for jumping from the current page points; and
determining the target website link according to the extracted website link.

9. The method according to claim 2, wherein the determining the website extraction function according to the character string comprised in the element class, and extracting the target website link from the element class by using the website extraction function, comprises:
in a case that the character string of the element class comprises a fourth target character string used for characterizing that a page jump is performed by a function for jumping from a current page, if the function for jumping from the current page points to a variable, performing, by using a seventh website extraction function, an abstract syntax tree analysis on the function for jumping from the current page to obtain a website link to which the function for jumping from the current page finally points; and
determining the target website link according to the obtained website link.

10. The method according to claim 1, wherein after the determining the element class comprised in the source codes, the method further comprises:
encapsulating the element class to obtain an encapsulated element class.

11. The method according to claim 1, wherein the extracting, based on the website extraction function matching the element class, the target website link comprised in the page to be analyzed from the element class, comprises:
extracting, based on the website extraction function matching the element class, website links comprised in the page to be analyzed from the element class; and
determining the target website link according to the extracted website links, wherein the target website link is a website link that belongs to a preset type.

12. The method according to claim 1, further comprising:
marking a website type to which the extracted target website link belongs, such that when a target page is generated based on the extracted target website link, a color matching the website type can be filled in a target position in the target page according to the website type.

13. (canceled)

14. A non-transitory computer-readable storage medium, storing a computer program which, when executed by a processing device, causes the processing device to implement:
acquiring source codes of a page to be analyzed;
determining an element class comprised in the source codes; and
extracting, based on a website extraction function matching the element class, a target website link comprised in the page to be analyzed from the element class.

15. An electronic device, comprising:
a storage device, storing a computer program; and
a processing device, configured to execute the computer program in the storage device to implement:
acquiring source codes of a page to be analyzed;
determining an element class comprised in the source codes; and
extracting, based on a website extraction function matching the element class, a target website link comprised in the page to be analyzed from the element class.

16. (canceled)

17. (canceled)

18. The non-transitory computer-readable storage medium according to claim 14, wherein the extracting, based on the website extraction function matching the element class, the target website link comprised in the page to be analyzed from the element class, comprises:
determining a website extraction function according to a character string comprised in the element class, and extracting the target website link from the element class by using the website extraction function, wherein the character string is used for characterizing a manner in which the element class implements a website link jump.

19. The non-transitory computer-readable storage medium according to claim 18, wherein the extracting, based on the website extraction function matching the element class, the target website link comprised in the page to be analyzed from the element class, comprises at least one of:
in a case that the character string of the element class comprises an anchor tag and a hypertext reference of the anchor tag comprises a first target character string used for characterizing a target script language, proxying and executing, by using a first website extraction function, a website jump function to which the hypertext reference points, to obtain a website link to which the website jump function points; and determining the target website link according to the website link to which the website jump function points, or
in a case that the character string of the element class comprises an anchor tag and a hypertext reference of the anchor tag does not comprise a first target character string used for characterizing a target script language, extracting, by using a second website extraction function, a website link to which the hypertext reference points; and determining the target website link according to the extracted website link, or
in a case that the character string of the element class comprises a second target character string used for characterizing a mouse click event and a third target character string used for characterizing that the mouse click event is implemented by calling a method for opening a new window, extracting, by using a third website extraction function, a target parameter in the method for opening the new window to obtain a website link comprised in the element class, wherein the target parameter is a parameter that characterizes a website link; and determining the target website link according to the website link comprised in the element class, or
in a case that the character string of the element class comprises a second target character string used for characterizing a mouse click event and does not comprise a third target character string used for characterizing that the mouse click event is implemented by calling a method for opening a new window, proxying and executing, by using a fourth website extraction function, the mouse click event to obtain a website link to which the mouse click event points; and determining the target website link according to the website link to which the mouse click event points, or
in a case that the character string of the element class does not comprise an anchor tag and does not comprise a second target character string used for characterizing a mouse click event, if a height of the element class is less than a preset pixel value, proxying and executing the element class by using a fifth website extraction function to obtain a website link to which the element class points; and determining the target website link according to the website link to which the element class points, or
in a case that the character string of the element class comprises a fourth target character string used for characterizing that a page jump is performed by a function for jumping from a current page, if the function for jumping from the current page points to a website link, extracting, by using a sixth website extraction function, the website link to which the function for jumping from the current page points; and determining the target website link according to the extracted website link, or
in a case that the character string of the element class comprises a fourth target character string used for characterizing that a page jump is performed by a function for jumping from a current page, if the function for jumping from the current page points to a variable, performing, by using a seventh website extraction function, an abstract syntax tree analysis on the function for jumping from the current page to obtain a website link to which the function for jumping from the current page finally points; and determining the target website link according to the obtained website link.

20. The non-transitory computer-readable storage medium according to claim 14, wherein the extracting, based on the website extraction function matching the element class, the target website link comprised in the page to be analyzed from the element class, comprises:
extracting, based on the website extraction function matching the element class, website links comprised in the page to be analyzed from the element class; and
determining the target website link according to the extracted website links, wherein the target website link is a website link that belongs to a preset type.

21. The electronic device according to claim 15, wherein the extracting, based on the website extraction function matching the element class, the target website link comprised in the page to be analyzed from the element class, comprises:
determining a website extraction function according to a character string comprised in the element class, and extracting the target website link from the element class by using the website extraction function, wherein the character string is used for characterizing a manner in which the element class implements a website link jump.

22. The electronic device according to claim 21, wherein the extracting, based on the website extraction function matching the element class, the target website link comprised in the page to be analyzed from the element class, comprises at least one of:
in a case that the character string of the element class comprises an anchor tag and a hypertext reference of the anchor tag comprises a first target character string used for characterizing a target script language, proxying and executing, by using a first website extraction function, a website jump function to which the hypertext reference points, to obtain a website link to which the website jump function points; and determining the target website link according to the website link to which the website jump function points, or
in a case that the character string of the element class comprises an anchor tag and a hypertext reference of the anchor tag does not comprise a first target character string used for characterizing a target script language, extracting, by using a second website extraction function, a website link to which the hypertext reference points; and determining the target website link according to the extracted website link, or
in a case that the character string of the element class comprises a second target character string used for characterizing a mouse click event and a third target character string used for characterizing that the mouse click event is implemented by calling a method for opening a new window, extracting, by using a third website extraction function, a target parameter in the method for opening the new window to obtain a website link comprised in the element class, wherein the target parameter is a parameter that characterizes a website link; and determining the target website link according to the website link comprised in the element class, or
in a case that the character string of the element class comprises a second target character string used for characterizing a mouse click event and does not comprise a third target character string used for characterizing that the mouse click event is implemented by calling a method for opening a new window, proxying and executing, by using a fourth website extraction function, the mouse click event to obtain a website link to which the mouse click event points; and determining the target website link according to the website link to which the mouse click event points, or
in a case that the character string of the element class does not comprise an anchor tag and does not comprise a second target character string used for characterizing a mouse click event, if a height of the element class is less than a preset pixel value, proxying and executing the element class by using a fifth website extraction function to obtain a website link to which the element class points; and determining the target website link according to the website link to which the element class points, or
in a case that the character string of the element class comprises a fourth target character string used for characterizing that a page jump is performed by a function for jumping from a current page, if the function for jumping from the current page points to a website link, extracting, by using a sixth website extraction function, the website link to which the function for jumping from the current page points; and determining the target website link according to the extracted website link, or
in a case that the character string of the element class comprises a fourth target character string used for characterizing that a page jump is performed by a function for jumping from a current page, if the function for jumping from the current page points to a variable, performing, by using a seventh website extraction function, an abstract syntax tree analysis on the function for jumping from the current page to obtain a website link to which the function for jumping from the current page finally points; and determining the target website link according to the obtained website link.

23. The electronic device according to claim 15, wherein the extracting, based on the website extraction function matching the element class, the target website link comprised in the page to be analyzed from the element class, comprises:
extracting, based on the website extraction function matching the element class, website links comprised in the page to be analyzed from the element class; and
determining the target website link according to the extracted website links, wherein the target website link is a website link that belongs to a preset type.
